(19) United States
(12) Patent Application Publication
(10) Pub. No.: US 2016/0261896 A1
(43) Pub. Date: Sep. 8, 2016

(54) SYSTEM AND METHOD FOR MOTION PICTURE EXPERT GROUP (MPEG) TRANSPORT STREAM SPLICING

(71) Applicant: International Datacasting Corporation, Kanata (CA)

(72) Inventors: Kirill Bocharnikov, Kanata (CA); Michael Heitner, Ontario (CA); Babak Shaikhvand, San Diego, CA (US)

(21) Appl. No.: 15/062,587

(22) Filed: Mar. 7, 2016

Related U.S. Application Data
(60) Provisional application No. 62/128,755, filed on Mar. 5, 2015.

(51) Int. Cl. H04N 21/234

(52) U.S. Cl. CPC H04N 21/23424

(57) ABSTRACT

A rate adaptation system or method is used in a subsystem to splice new content into a live stream to form a spliced stream. The live stream comprises a first plurality of frames contained within a first plurality of packets, and the new content comprises a second plurality of frames contained within a second plurality of packets. The system or method monitors the first plurality of packets and increments a live stream frame count when a new frame is encountered within the first plurality of packets; monitors the second plurality of packets and increments a new content frame count when a new frame is encountered within the second plurality of packets; and determines when the live stream frame count is greater than the new content frame count by a predetermined amount and replaces the first plurality of packets with the second plurality of packets.

### CROSS-REFERENCE TO RELATED APPLICATION(S)

This application claims priority to U.S. Provisional Application No. 62/128,755, filed Mar. 5, 2015, which is hereby incorporated by reference herein in its entirety.

### FIELD OF THE INVENTION

The present disclosure relates to the transmission and splicing of Motion Picture Expert Group transport streams. More specifically, it relates to slicing two transport streams with differing clock rates.

### BACKGROUND OF THE INVENTION

MPEG transport streams or media streams have program clock references (PCRs) encoded in the data to allow a decoder to generate a system timing clock from the received transport stream. The PCRs are generated by an encoder and allow a decoder to display the media that these streams carry accurately.

When new content is spliced into a live stream, the PCRs in the new content cause a discontinuity and therefore decoders are unable to decode the spliced content properly. One possible solution is to use hardware clocks to recover or “re-stamp” the PCRs within splicers but there are several problems with using hardware clocks. Since each hardware clock on each splicer unit is non-identical to the other, this process will never produce identical values at each splicer. This makes such an implementation incompatible for Single Frequency Networks (SFNs) which require “bit identical” content from all the transmitter units in a cluster so that a downstream receiver can correctly decode the information.

Secondly, using hardware clocks on each of the splicers require that the hardware clocks be highly accurate. This may increase overall splicer cost. Additionally, the accuracy of the hardware clocks must be maintained. This will require that each hardware clock on each splicer be continuously updated and compensated for any drift. Therefore, there is a requirement for solutions which are not dependent on the hardware clocks in the splicer.

When new content is spliced into a transport stream existing approaches are to simply insert the new packets into the live stream. However, this has several drawbacks. MPEG streams have metrics in place that measure the distances and timing between specific portions of the stream to detect errors. Inserting the new content in its entirety into the live content changes the structure of the live stream and these metrics would become invalid. Furthermore, there are metrics for SFN networks to measure structural identicality between the streams broadcast by the various transmitters. Changing the structure of the live stream will make these metrics invalid. Therefore, there is a need for a more intelligent solution to overcome these problems.

When performing splicing, it is advantageous to match the transport stream rate of the new content with the stream rate of live stream. The entirety of the content to be inserted needs to be present in the outgoing stream, while preserving overall rate. If there is a mismatch in the transport stream rate, then there is a difference in the number of packets transmitted within each stream. For example, if the new content data stream rate is higher than the live stream stream rate then the number of packets transmitted in the new content stream is higher than that of the live stream stream within the same time window. Conversely if the new content stream rate is lower than the live stream stream rate then the number of packets transmitted in the new content stream is lower than that of the live stream stream within the same time window. There is a need for a solution to overcome this problem.

### BRIEF SUMMARY

According to one embodiment of the invention, a rate adaptation system or method is used in a subsystem to splice new content into a live stream to form a spliced stream. The live stream and new content are received and stored. The live stream comprises a first plurality of frames contained within a first plurality of packets, and the new content comprises a second plurality of frames contained within a second plurality of packets. The system or method monitors the first plurality of packets and incrementing a live stream frame count when a new frame is encountered within the first plurality of packets; monitors the second plurality of packets and incrementing a new content frame count when a new frame is encountered within the second plurality of packets; and determines that the live stream frame count is greater than the new content frame count by a predetermined amount and replaces the first plurality of packets with the second plurality of packets.

In some embodiments, the rate adaptation processor performs the replacing by replacing null packets in the first plurality of packets with packets from the second plurality of packets. In other embodiments of the invention, the rate adaptation processor performs the replacing by replacing no data packets in the first plurality of packets with packets from the second plurality of packets. In some embodiments the predetermined amount is zero.

In a further embodiment of the invention, a rate adaptation module is used in a subsystem to splice new content into a live stream to form a spliced stream. The module comprises an input adaptation buffer receiving and storing therewithin the live stream and new content. The live stream comprises a first plurality of frames contained within a first plurality of packets. The new content comprises a second plurality of frames contained within a second plurality of packets. A rate adaptation processor is coupled to the input adaptation buffer. The rate adaptation processor monitors the first plurality of packets and increments a live stream frame count when a new frame is encountered within the first plurality of packets. The rate adaptation processor monitors the second plurality of packets and increments a new content frame count when a new frame is encountered within the second plurality of packets. The rate adaptation processor determines that the live stream frame count is less than the new content frame count by a predetermined amount and converts the first plurality of packets into no payload packets. In some embodiments the predetermined amount is zero.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an example embodiment of a Single Frequency Network.

FIG. 2 shows a system diagram of a splicer incorporating a rate adaptation module.

FIG. 3 shows rate adaptation module in further detail.

FIG. 4 shows an overall flowchart of an example embodiment for splicing together live stream and new content.

FIG. 5 shows a flowchart of an example embodiment of step 403 of FIG. 4.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

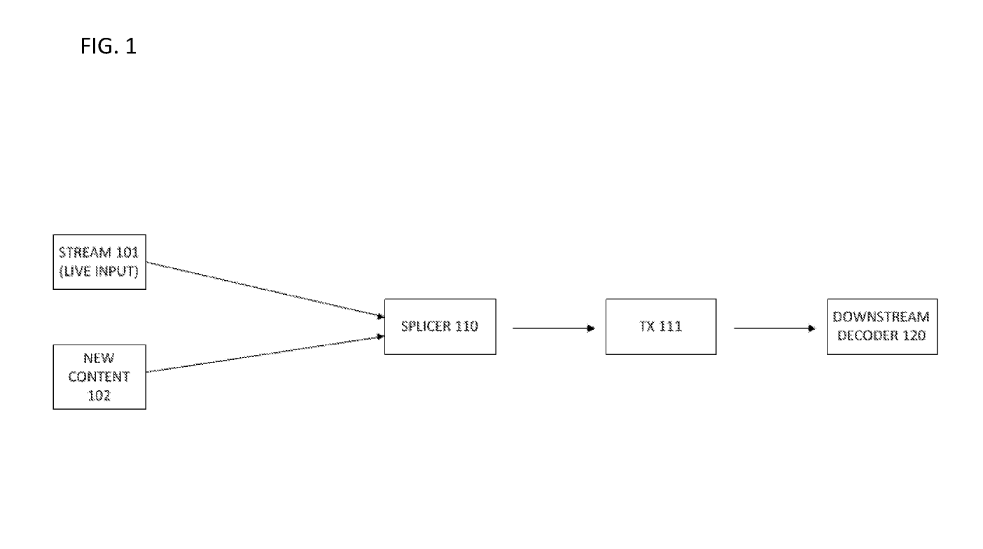

FIG. 1 shows an example arrangement for a Single Frequency Network (SFN). content from a Motion Picture Expert Group (MPEG) live input stream 101 being fed to a transport stream splicer 110. At the splicer, live stream 101 is spliced with new content 102, and the output spliced stream is sent to a transmitter 111. This output spliced stream is transmitted; and received and decoded by a downstream receiver/decoder 120.

The live stream 101 and new content 102 contain multiple types of packets, such as, for example, video and audio packets. One example of new content 102 would be a stream of advertising. The new content may be data stored locally on a hard drive within the splicer, or data stored in remote storage, or any other stream input into the splicer that is different from the live stream 101. While these examples have been presented, it is known to one of skill in the art that new content is not limited to only these examples of sources.

Again referring to FIG. 1, when performing splicing, it is necessary to match the transport stream rate of the new content 102 with the stream rate of live stream 101. The entirety of the content to be inserted needs to be present in the outgoing stream, while preserving the overall rate.

If there is a mismatch in the transport stream rate, then there is a difference in the number of packets transmitted within each stream. For example, if the new content 102 data stream rate is higher than the live stream 101 stream rate then the number of packets transmitted in the new content 102 stream is higher than that of the live stream 101 stream within the same time window. Conversely if the new content 102 stream rate is lower than the live stream 101 stream rate then the number of packets transmitted in the new content 102 stream is lower than that of the live stream 101 stream within the same time window.

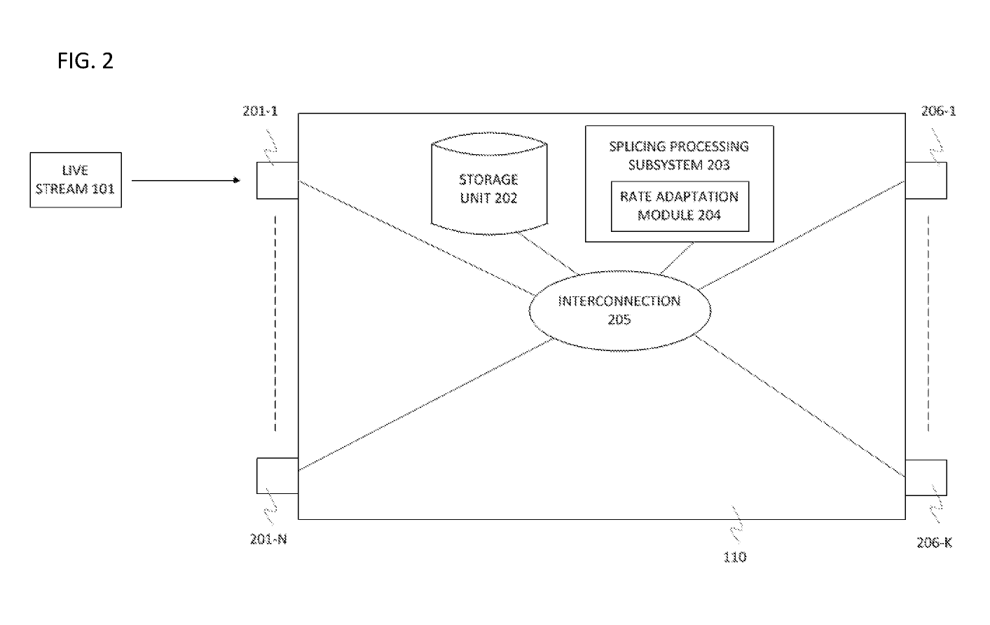

An example implementation of the system and method described within this section within splicer 200-1 is shown in FIG. 2. The live stream 101 is fed into the splicer 110 from a first input 201-1. The new content is either stored on storage unit 202, or fed from another input such as 201-N.

Live stream 101, new content 102 and data associated with the live stream 101 and new content 102 are then fed to splicing processing subsystem 203 which, as shown in FIG. 2, is modified to comprise rate adaptation module 204.

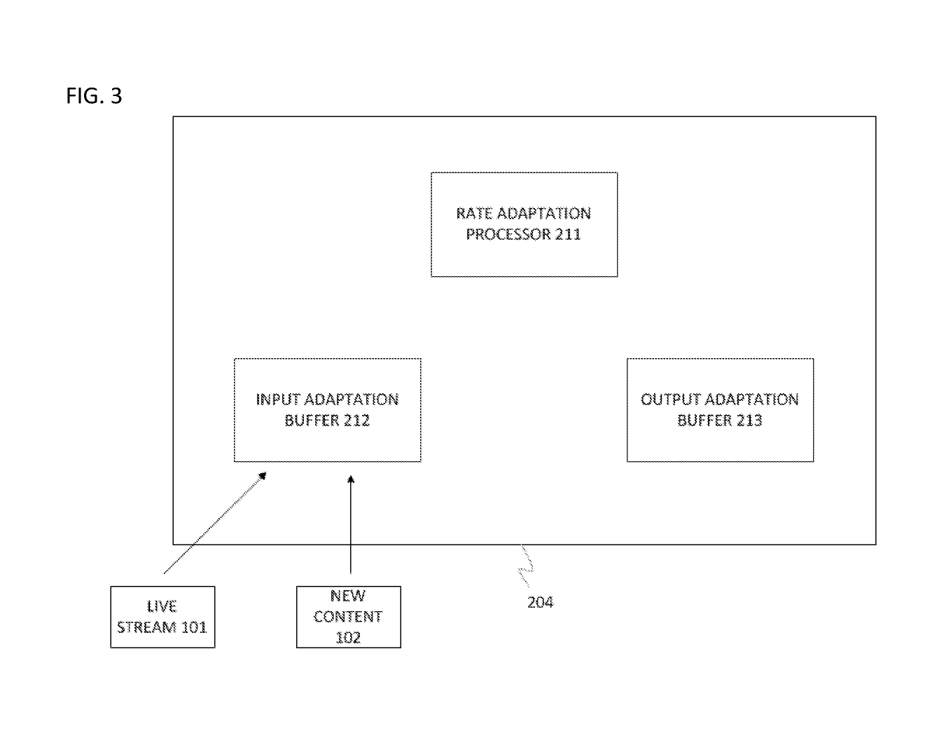

Rate adaptation module 204 is shown in further detail in FIG. 3. This module performs the rate adaptation to be described below. The rate adaptation module comprises a rate adaptation processor 211, an input adaptation buffer 212, and an output adaptation buffer 213.

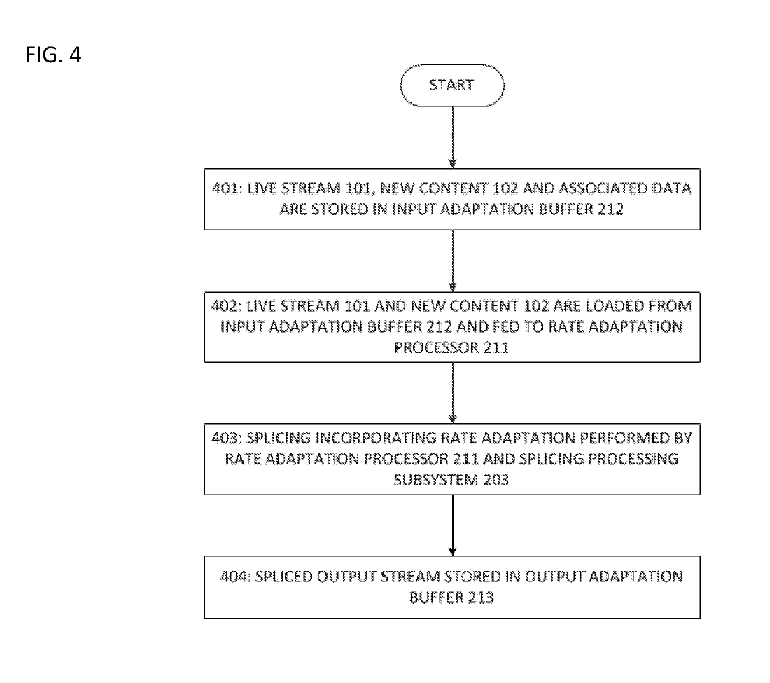

FIG. 4 shows a flowchart of an example embodiment for splicing together live stream 101 and new content 102 incorporating rate adaptation. In step 401 live stream 101; new content 102; and data associated with the live stream 101 and new content 102 are initially stored in the input adaptation buffer 212 as shown in FIG. 4.

Then, in step 402, the live stream and the new content are loaded from input adaptation buffer 232, and fed to the adaptation processor 231.

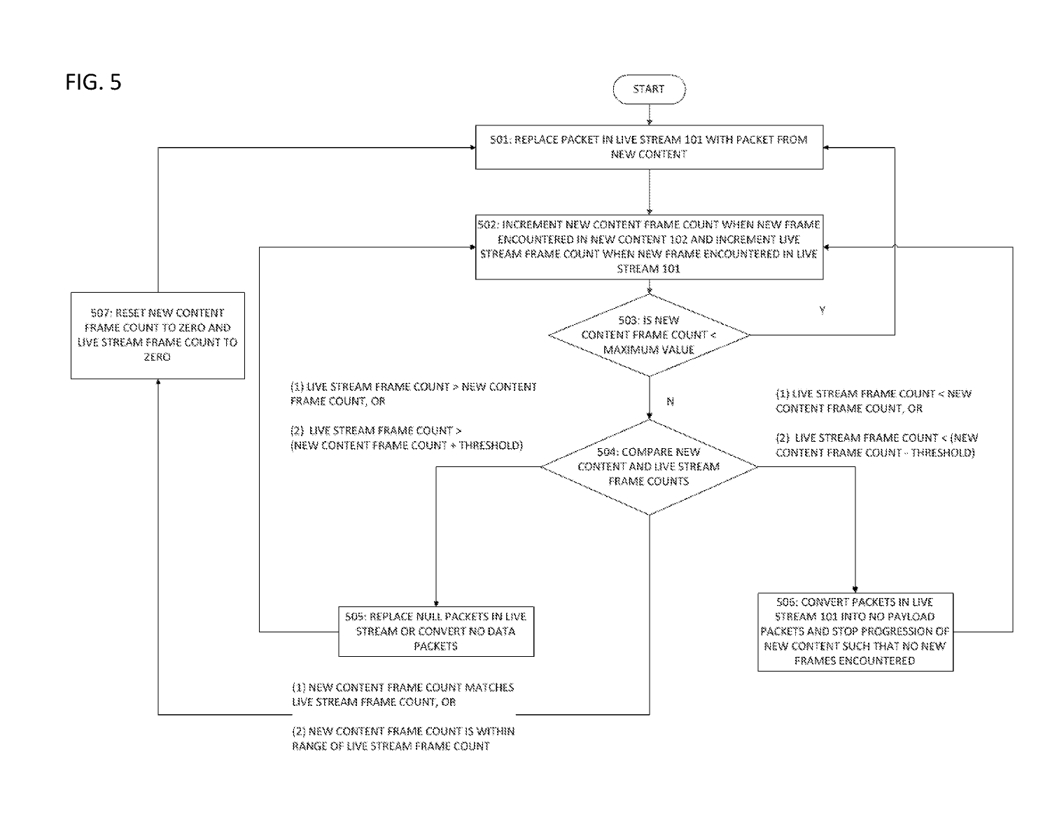

In step 403, the splicing of the live stream 101 together with the new content 102 which incorporates rate adaptation is performed by the rate adaptation processor 211 in conjunction with the splicing processing subsystem 203. FIG. 5 shows an example flowchart for an embodiment of step 403 for a portion of the live stream 101 which is to be replaced by new content 102. The portion of the live stream 101 which is to be replaced comprises a first plurality of frames and a first plurality of packets. The new content 102 comprises a second plurality of frames and a second plurality of packets. In a further embodiment, each of the first plurality of frames comprises a corresponding portion of said first plurality of packets; and each of the second plurality of frames comprises a corresponding portion of said second plurality of packets.

In step 501, a packet from the new content 102 is inserted in place of a packet in a portion of the live stream 101 which is to be replaced. The type of packet is matched before replacement. For example, a video packet from new content 102 is used to replace a video packet from live stream 101; and an audio packet from new content 102 is used to replace an audio packet from live stream 101.

The live steam and the new content is not constant and frames are not constantly being received. Furthermore, not all frames contain content. In step 502, a new content frame count is incremented every time a new frame in the new content 102 is encountered, and a live stream frame count is incremented every time a new frame in the portion of live stream 101 to be replaced is encountered.

In step 503, the new content frame count is compared to a maximum number X. In one embodiment, X is determined based on historical estimates. If the new content frame count is less than X, then packet replacement continues. If the new content frame count is equal to X, then in step 504 the new content frame count is compared to the live stream frame count.

If
the live stream frame count is greater than the new content frame count, or
the live stream frame count is greater than the new content frame count plus a first threshold, that is:

NF_{LIVE}>NF_{NEW}+α₁

where, NF_{LIVE} is the live stream frame count
NF_{NEW} is the new content frame count
Δ₁ is a first threshold
   then new content packets are inserted into the live stream using a variety of methods. One method is for packets from new content 102 to replace packets from live stream 101 until the frame counts match, or are within a threshold. Another is for new content packets to replace NULL packets from live stream 101 until the frame counts match, or are within a threshold. If there are “no data” packets in the new content available in other media streams, then a flag may be set indicating that “no data” packets from other media streams may be converted to accommodate the new content packet to be inserted. The frame counts are incremented in a return to step 502, and in step 504 the frame counts are compared again. Step 505 is performed until the frame counts match, or are within the first threshold.

If the live stream frame count is less than the new content frame count, then in one embodiment, in step 506 packets from live stream 101 are converted into “No payload” packets until the frame counts match. In a further embodiment, step 506 is performed if the live stream frame count is less than the new content frame count minus a second threshold, that is:

NF_{LIVE}<NF_{NEW}−Δ₂

where NF_{LIVE} is the live stream frame count
NF_{NEW} is the new content frame count
Δ₂ is a second threshold
   In an embodiment, conversion into “No payload” packets is achieved by setting the payload flag to zero. This is achieved by setting the 2nd bit of adaptation field control. The live stream 101 frame progression continues, but the progression of frames in the new content 102 is stopped such that no new frames are encountered in new content 102. Then upon return to step 502, the new content frame count stays static while the live stream frame count is incremented. Then in step 504 the frame counts are compared again. Step 506 is performed until the frame counts match, or are within the second threshold.

If in step 504 the live stream 101 frame count is either equal to the new content 102 frame count or within a range based on the new content frame count, that is:

NF_{NEW}−Δ₂≦NF_{LIVE}≦NF_{NEW}+Δ₁

where NF_{LIVE} is the live stream frame count
NF_{NEW} is the new content frame count
Δ₁ is a first threshold
Δ₂ is a second threshold
   then in step 507, the new content frame count and live stream frame count are reset to zero, and finally step 501 continues to be performed.

In a further embodiment, the first threshold and the second threshold are equal to each other.

In one embodiment, more than one portion of live stream 101 is replaced by new content 102. Then in this embodiment, step 503 is performed for all portions of the live stream that are to be replaced with new content 102.

Then, returning to FIG. 4, in step 504, the spliced output stream is stored in the output adaptation buffer 213.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A rate adaptation module for use in a subsystem to splice new content into a live stream to form a spliced stream, the module comprising:
an input adaptation buffer receiving and storing therewithin the live stream and new content, the live stream comprising a first plurality of frames contained within a first plurality of packets, the new content comprising a second plurality of frames contained within a second plurality of packets; and
a rate adaptation processor coupled to the input adaptation buffer, the rate adaptation processor monitoring the first plurality of packets and incrementing a live stream frame count when a new frame is encountered within the first plurality of packets, the rate adaptation processor monitoring the second plurality of packets and incrementing a new content frame count when a new frame is encountered within the second plurality of packets, the rate adaptation processor determining that the live stream frame count is greater than the new content frame count by a predetermined amount and replacing the first plurality of packets with the second plurality of packets.

2. The module of claim 1 wherein the rate adaptation processor performs the replacing by replacing null packets in the first plurality of packets with packets from the second plurality of packets.

3. The module of claim 1 wherein the rate adaptation processor performs the replacing by replacing no data packets in the first plurality of packets with packets from the the second plurality of packets.

4. The module of claim 1 wherein the predetermined amount is zero.

5. A rate adaptation module for use in a subsystem to splice new content into a live stream to form a spliced stream, the module comprising:
an input adaptation buffer receiving and storing therewithin the live stream and new content, the live stream comprising a first plurality of frames contained within a first plurality of packets, the new content comprising a second plurality of frames contained within a second plurality of packets;
a rate adaptation processor coupled to the input adaptation buffer, the rate adaptation processor monitoring the first plurality of packets and incrementing a live stream frame count when a new frame is encountered within the first plurality of packets, the rate adaptation processor monitoring the second plurality of packets and incrementing a new content frame count when a new frame is encountered within the second plurality of packets, the rate adaptation processor determining that the live stream frame count is less than the new content frame count by a predetermined amount and converting the first plurality of packets into no payload packets.

6. The module of claim 5 wherein the predetermined amount is zero.

7. A rate adaptation method of splicing new content into a live stream to form a spliced stream, the method comprising:
receiving and storing in an input adaptation buffer the live stream and new content, the live stream comprising a first plurality of frames contained within a first plurality of packets, the new content comprising a second plurality of frames contained within a second plurality of packets;
monitoring the first plurality of packets and incrementing a live stream frame count when a new frame is encountered within the first plurality of packets;
monitoring the second plurality of packets and incrementing a new content frame count when a new frame is encountered within the second plurality of packets; and
determining that the live stream frame count is greater than the new content frame count by a predetermined amount and replacing the first plurality of packets with the second plurality of packets.

8. The rate adaptation method of claim 7 wherein said replacing replaces null packets in the first plurality of packets with packets from the second plurality of packets.

9. The rate adaptation method of claim 7 wherein said replacing replaces no data packets in the first plurality of packets with packets from the the second plurality of packets.

10. The rate adaptation method of claim 7 wherein the predetermined amount is zero.

11. A rate adaptation method for splicing new content into a live stream to form a spliced stream, the method comprising:
receiving and storing therewithin the live stream and new content, the live stream comprising a first plurality of frames contained within a first plurality of packets, the new content comprising a second plurality of frames contained within a second plurality of packets;
monitoring the first plurality of packets and incrementing a live stream frame count when a new frame is encountered within the first plurality of packets;
monitoring the second plurality of packets and incrementing a new content frame count when a new frame is encountered within the second plurality of packets;
determining that the live stream frame count is less than the new content frame count by a predetermined amount and converting the first plurality of packets into no payload packets.

12. The rate adaptation method of claim 11 wherein the predetermined amount is zero.
